(19) United States
(12) Patent Application Publication
(10) Pub. No.: US 2024/0023537 A1
(43) Pub. Date: Jan. 25, 2024

(54) APPLICATOR AND DEVICE FOR APPLYING ELECTRICAL CURRENT INTO A PLANT

(71) Applicants: Zasso Group AG, Zug (CH); Zasso Brasil Indústria e Comércio de Máquinas Ltda., Indaiatuba (BR)

(72) Inventors: Sergio de Andrade COUTINHO FILHO, Indaiatuba (BR); Guilherme Penna Moreira RINZLER, São Paulo (BR); Christopher FREIMANN, Eschweiler (DE)

(73) Assignees: Zasso Group AG, Zug (CH); Zasso Brasil Indústria e Comércio de Máquinas Ltda., Indaiatuba (BR)

(21) Appl. No.: 18/265,625

(22) PCT Filed: Oct. 22, 2021
(86) PCT No.: PCT/BR2021/050465

§ 371 Date: Jun. 6, 2023

(51) Int. Cl. A01M 21/04; A01M 19/00

(52) U.S. Cl. CPC A01M 21/046; A01M 19/00

(57) ABSTRACT

The present invention refers to an applicator (20, 30, 40, 50) for applying electrical current into a plant, the applicator arranged to be carried by a moving carrier, comprising: at least one support structure (18) comprising a connecting member (17) for attaching the applicator to the moving carrier and locomotion means (22, 31, 36) for moving the applicator along with the carrier; and at least one conductive electrode (24, 34, 35, 54) attached to the support structure (18) and connectable to a terminal of an electrical power source, the at least one conductive electrode (24, 34, 35, 54) comprising a contacting surface for contacting the plant as the applicator is moved by the carrier, wherein a length of the contacting surface extends in the movement direction and is greater than a width of the contacting surface.

### FIELD OF THE DISCLOSURE

The present invention relates to an electrical current applicator for the application of electricity in plants, pulled or carried by a moving carrier (such as tractor), to eradicate harmful pests, such as nematodes and other root-borne organisms.

### DESCRIPTION OF THE RELATED ART

In the field of agricultural industry, it is commonly known that soil-borne pests must be eradicated or diminished from agricultural fields prior to planting crops therein. Therefore, it is very relevant for agricultural productivity to control or diminish the population of soil parasites, since without such eradication, nematodes and other organisms that are commonly found in the soil may affect, delay, or even prevent the subsequently introduced plants from proper growth.

Several weed and pest eradication apparatuses have been developed in the prior art based on the use electricity for pest eradication purposes. Generally weed eradication apparatus rely upon touching the above-ground portions of growing weeds (leaves or stems) with electrically charged conductors for eradication purposes.

Document CN112913828A discloses a field weeding device and a tractor comprising the apparatus, including a frame, and the frame securing the floating mechanism and the weed monomer, the weeding device comprises a height adjustment frame, an insulating connection frame, an angle adjustment shelf, herbicide plate mounting frame, insulated slide, slant electrode plate, wheel. The electrode plate is connected to the high-frequency high pressure of the power supply system, and the electrode plate is induced, and the high-voltage current is introduced into the ground to form a current passage through the weeds and leaves. The current will cause weed damage to weed damage effect.

Document US20060265946A1 discloses an electro mechanic device, generator of electric discharges to eradicate noxious weeds by using an electrode subdivided into smaller electrodes, called multiple electrodes, that reduces the number of plants that receive the electric discharge simultaneously and consequently the required power to be supplied by the generator is reduced, significantly improving the yield of the electrocution process.

As for eradication of soil-borne pests, other known apparatuses utilize structures that penetrate the soil to eradicate the soil-borne pests, including nematodes and the like.

Document U.S. Pat. No. 10,188,045 discloses an apparatus for passing electrical current through soil that takes into account the adjacent soil condition prior to discharging the electrical current, wherein the apparatus, will automatically adjust the amount of electrical current that is discharged into the soil adjacent the electrically charged components so as to eradicate the soil-home pests more effectively and efficiently. According to U.S. Pat. No. 10,188,045, the electrical energy is introduced in the soil as a whole through stinger shanks, covering and ensuring that enough energy is spent in all the volume of the soil, to kill the nematodes.

However, the present inventors found that the application of electrical energy into the soil could be used in general cases but does not provide an efficient solution for root borne nematodes.

Moreover, the electrical energy that is introduced in the soil through stinger shanks would be sufficient to cover the whole volume of the soil to ensure to kill the nematodes which represent an infimal percentage of the volume.

Root borne Nematodes spend a significant amount of time of their life-cycle directly physically connected to the roots of the host plant. Considering the xylem and phloem of the plants are a low impedance electrical conductor to the root borne nematodes, it would be energetically more efficient to use the plant as the active electrode, instead of introducing the energy directly through stinger shanks.

By introducing this amount of energy in the soil, it is also inevitable to damage other beneficial soil organisms, which may be undesirable. In this sense, the mechanical effect of changing the soil compactness and structure through stinger shanks introduced inside the soil have a known negative effect in the capacity of several beneficial organisms such as earthworms and collembola to reproduce—if they are not fully eliminated, which is likely given the increased amount of energy spent in the whole volume of the top layer of soil, to the depth of the stinger shanks.

Furthermore, root borne nematodes are an increased issue with high humidity and irrigated soils that suffer no dry periods of non-host plants to help naturally control their population, which is not properly conducted according to the prior art techniques. Hence, it is specifically necessary to control root borne nematodes in low impedances scenarios promoted by said high humidity, and for economical purposes for the solution to minimize energy per area, covering the maximum amount of unit of area per unit of time while minimizing the amount of energy spent on electrifying the non-target soil parcels.

Therefore, although the state of the art comprises some techniques for applying electrical current into plants, there is a need for an apparatus that ensure the connection, optimizes the electrical path, ensures the usage of maximum power and enough energy, while not wasting electrical energy to heat up the soil and minimizing effects on other potentially beneficial organisms.

### SUMMARY OF THE INVENTION

The present invention provides an applicator for applying electrical current into a plant, the applicator arranged to be carried by a moving carrier, comprising: at least one support structure comprising a connecting member for attaching the applicator to the moving carrier and locomotion means for moving the applicator along with the carrier; and at least one conductive electrode attached to the support structure and connectable to a terminal of an electrical power source, the at least one conductive electrode comprising a contacting surface for contacting the plant as the applicator is moved by the carrier, wherein a length of the contacting surface extends in the movement direction and is greater than a width of the contacting surface.

The present invention provides a device for applying electrical current into a plant, comprising a moving carrier, an electrical power source and at least one applicator for applying electrical current into a plant, the applicator arranged to be carried by a moving carrier, comprising: at least one support structure comprising a connecting member for attaching the applicator to the moving carrier and locomotion means for moving the applicator along with the carrier; and at least one conductive electrode attached to the support structure and connectable to a terminal of an electrical power source, the at least one conductive electrode comprising a contacting surface for contacting the plant as the applicator is moved by the carrier, wherein a length of the contacting surface extends in the movement direction and is greater than a width of the contacting surface.

### BRIEF DESCRIPTION OF THE DRAWINGS

The invention is explained in greater detail below on the basis of figures. Shown therein are:

FIG. 1 shows a system for eradicating root-borne organisms by applying electrical current into a host plant according to the present invention.

FIG. 2 shows a device eradicating root-borne organisms by applying electrical current into a host plant according to a first embodiment of the present invention.

FIG. 3 shows a rear perspective view of the device shown in FIG. 2.

FIG. 4 shows a device according to a second embodiment of the present invention.

FIG. 5 shows a device according to a fifth embodiment of the present invention.

FIG. 6 shows a device according to a third embodiment of the present invention.

FIG. 7 shows a device according to a fourth embodiment of the present invention.

### DETAILED DESCRIPTION OF THE INVENTION

The following description is based on preferred embodiments of the invention applied to an applicator for applying electrical current into a plant, which is arranged to be carried by a moving carrier. However, the present invention is not limited to a particular embodiment, as it will be clear for a skilled person.

Generally, the present invention relates to applicator for applying electrical current into a plant, the applicator being arranged to be carried by a moving carrier, comprising: at least one support structure comprising a connecting member for attaching the applicator to the moving carrier and locomotion means for moving the applicator along with the carrier; and at least one conductive electrode attached to the support structure and connectable to a terminal of an electrical power source, the at least one conductive electrode comprising a contacting surface for contacting the plant as the applicator is moved by the carrier, wherein a length of the contacting surface extends in the movement direction and is greater than a width of the contacting surface.

FIG. 1 shows a device for applying electrical current into a plant comprising different embodiments of the applicators according to the present invention. Preferably, the device comprises a moving carrier 10, a careen 12 and a chassis for holding the applicators and connecting them to the careen 12 and the moving carrier 10. For illustrative purposes, the applicators of the different embodiments are depicted in a linear row connected by means of the central bar 16 of the chassis. However, according to the present invention at least one applicator must be connected to the moving carrier 10. In addition, although the combination of the different embodiments is shown, preferably, the same type of applicators is used in the device as it will be clear from the description of the present invention.

Typically, the moving carrier 10 travels through the soil region to be treated pulling and, thus, moving, the applicators enabling the contact with the host plants. The moving carrier 10 is shown as a tractor, however other vehicles, such as cars or hand pulled trolleys, may be used within the context of the present invention. Yet, the use of a tractor provides preferential advantages such as the use of a power takeoff (PTO) 13 of the tractor combined with an alternator as an electrical energy source 14, which are housed within a careen 12. In this exemplificative embodiment, the energy source 14 is an alternator connected to an electronic converter for supplying DC electrical energy to the applicators.

The application of electrical energy into plants is already known from the prior art. For example, document US20200205395A1 describes the dynamic adjustment of current for electrical weeding: instead of application a DC electrical current through power distribution modulation (PDM) and the technology described at US20060265946A1, which modulation is in approximately the same frequency range as the main frequency (0.5-100 Hz and 50-65 Hz), the Individual Transformer PDM Current Control modulates at the proposed range of from 100 Hz to 10 kHz. This frequency itself, although necessarily smaller than the DC/AC converter (usually a square-wave h-bridge inverter) frequency, is in a much higher range. But unlike proposed by U.S. Pat. No. 10,188,045, where the current adjustment, (generally electronically controlled by PDM or pulse width modulation (PWM)— method described by document US20200205395A1) should be done in relation to soil specificities.

Assuming constant or semi-constant voltage and current dynamic adjustments, the current delivered, by the equipment to the purpose of controlling root borne nematodes, should not be in relation to the soil conditions, but should be only limited by the power source, such as an alternator connected to the tractor, which provides limited power. This would ensure the maximum use of the power source, therefore ensuring efficiency of use of the installed control capacity.

Therefore, an ideal system should adjust the ideal energy per area to an amount that is lethal for root borne nematodes by changing the area and time of exposure (instead of current), by changing the driving speed or boom size, while making the most of the available power, delivered in a constant or semi-constant fashion. This further allows for the targeted organisms that are connected to the roots to be exposed to a higher electrical energy, ensuring none or minimized effect on beneficial organisms such as earthworms or collembola that are not necessarily physically attached to the roots.

For that, it is necessary to consider the use of new constant semi-constant power sources for electrical weeding, such as the one described by US20190320641A1, which allows to use small, cheap and available electronic components to comprise a high power-factor converter that controls for power without the need of software or other larger components required in previous technological generations. Still, as the impedance matching happens in self-adjustable way, this converter topology presents a self-adjustable power control without the necessity of a control strategy implementation.

In the preferred embodiments, the energy source is an alternator connected to an electronic converter. Thus, the PTO 13 provides mechanical energy to be converted by the alternator, which may provide electrical energy. Typically, the alternator is configured to provide a triphasic voltage between 110 and 440 V, at 50 to 65 Hz and 10 to 200 kW. The energy provided by the alternator is input into the electronic converter, which outputs a dynamic voltage that ensure constant or semi constant power. Typically, the voltage would be DC and vary from 1 kV to 20 kV.

Controlling root borne nematodes through the application of electrical energy in the host plant air system may damage or kill said host plants. This is due to the fact that unlike other potentially beneficial soil organisms, and as the targeted root borne nematodes, a high percentage of the electrical energy applied will be consumed by the plant. Therefore, it is ideal to apply on the plants post-harvest when the planted crops have no commercial value. After harvest, crops such as soybeans, sugarcane and corn leaves stems behind as seen in FIG. 1. These stems are ideal to ensure an electrical connection to the targeted root borne nematodes, since they have low or no commercial value, therefore it is not an issue if the plant is killed. Additionally, just after harvest the plants offer a low impedance path, while the targeted organisms are still connected to their roots. Therefore, one aspect of the present invention aims at using the stems of the post harvested plants to apply the electrical energy. Yet, the applicators according to the present invention may be used in order to apply energy by means of other parts of the plants, but without fully achieving these advantages. Alternatively, the present invention may also be applicable to crops of different vegetations, for example, non-commercial plants such as trap plants. Still, the applicators may also be used to apply electrical energy into plants for desiccating.

The applicators are coupled to the tractor 10 and the careen 12 by means of a chassis, which is preferably composed of a hinged structure formed by a central bar 16 and connecting members 15 and 17. The central bar 16 is disposed to hold several applicators according to the intended application or width of field to be treated. Each applicator module is connected to the central bar 16 by means of connecting member 17 and to the careen 12 by the connecting member 15. According to the preferred embodiment, the connecting members 15, 17 comprises hinged ends, which enables the movement of the chassis even when the moving carrier 10 travels along an irregular soil region. Therefore, the hinged features of the connecting members 15, 17 enables the stabilization of the applicators in uneven terrains allowing the contact with the stems even in such situations.

Preferably, the elements of the chassis are insulated for safety reasons. In addition, the chassis comprises and may house the means for the electrical connection of the applicators with the energy source.

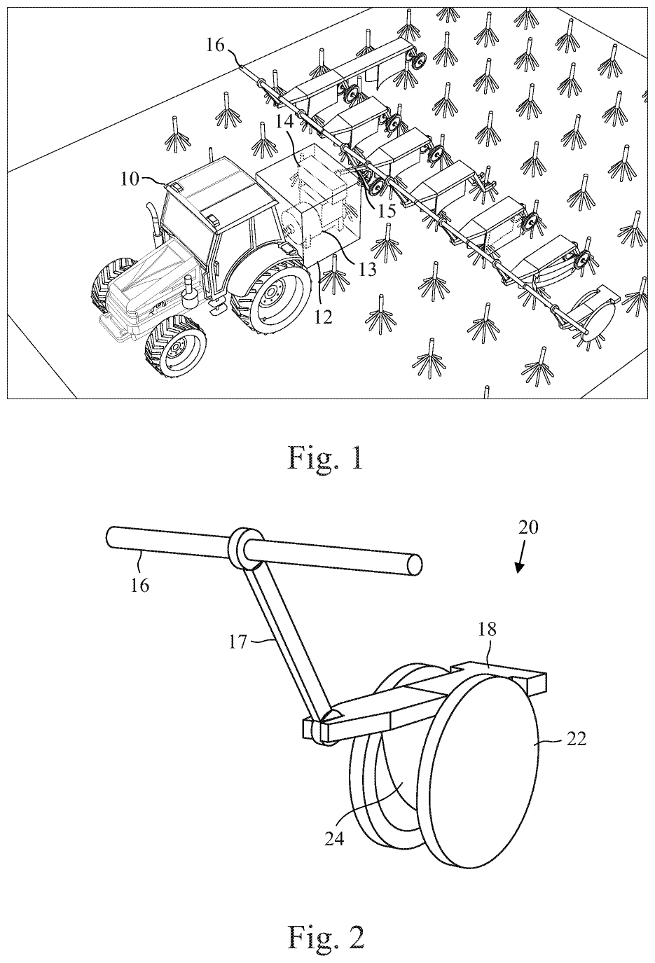

FIG. 2 shows a first embodiment of an applicator 20 according to the present invention. As it can be seen, the applicator 20 comprises one support structure 18 attached to a connecting member 17, which connects the applicator to the moving carrier 10. In addition, the applicator 20 comprises locomotion means for moving the applicator along with the moving carrier (10). Preferably, the locomotion means are wheels 22.

Moreover, the applicator 20 comprises one conductive electrode 24 attached to the support structure 18 and connected to a terminal of the electrical power source 14 through the chassis. The conductive electrode 24 comprises a contacting surface for contacting the plant and, thus, applying the electrical energy as the device is moved by the carrier, wherein a length of the contacting surface extends in the movement direction and is greater than a width of the contacting surface for increasing the contact surface and time of the electrode with the stem of the host plant.

As stated before, the control of the soil region occurs after harvest, when crops such as soybeans, sugarcane and corn leave small stems behind. These stems are ideal to ensure an electrical connection to the targeted root borne nematodes, since they have low or no commercial value, therefore it is not an issue if the plant is killed. Specially just after harvest, the stems of the plant offer a low impedance path, while the targeted organisms are still connected to their roots. Therefore, the applicator according to the present invention increases and ensures contact with the stems of the plants after harvest.

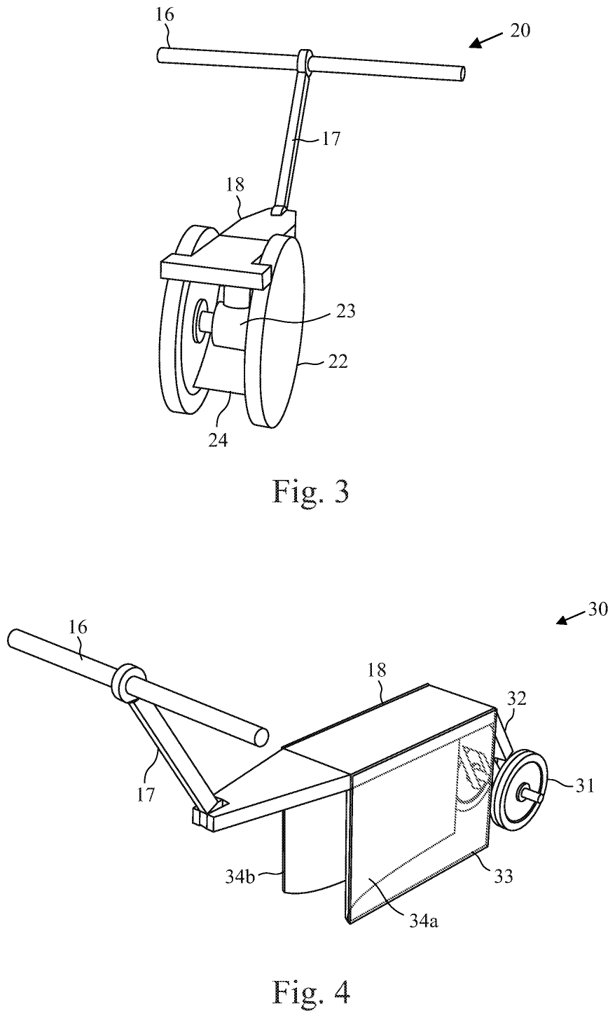

Preferably, the conductive electrode 24 is a curved plate electrode that is attached to the support structure 18 and the contacting surface faces the movement direction of the device. As seen in FIG. 2, the conductive electrode 24 extends downward from the support structure 18. FIG. 3 shows a rear perspective view of the applicator 20, wherein the conductive electrode 24 extends to as to be substantially horizontal on the end.

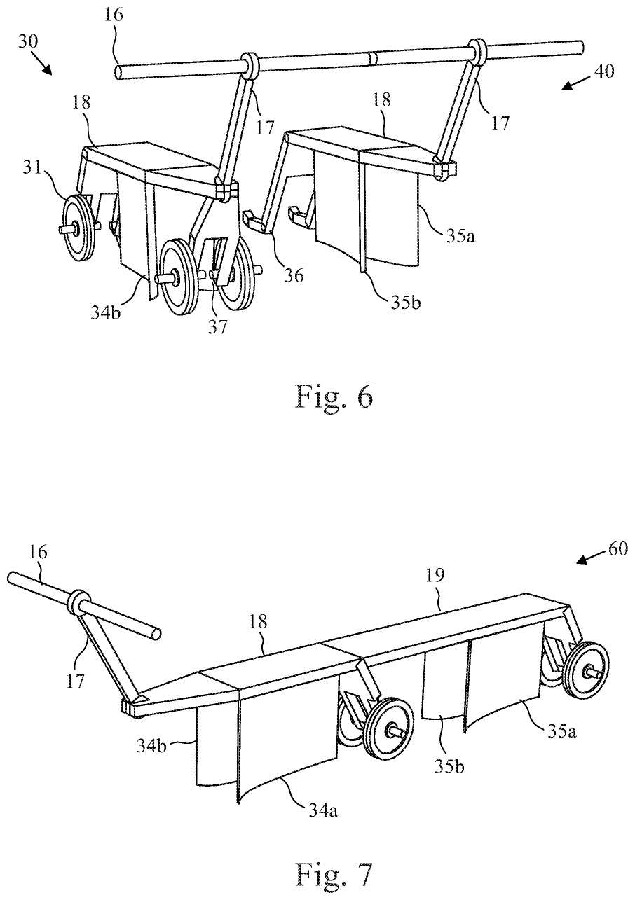

The applicator 20 comprises locomotion means for enabling the applicator 20 to properly move along with the moving carrier 10 over the crop field. Preferably, the locomotion means are wheels 22 that are attached to the support structure 18 by means of a wheel support 23. However, other locomotion means such as skis 36 (as seen in FIG. 6). In this case, the conductive electrode 24 curvature may extend between the wheels 22. Moreover, the wheels 22 are made of an insulating material. This preferred feature is advantageous for optimizing the energy consumption, since it prevents the contact of the conductive electrode with undesired bodies further increasing the safety of the operation.

The conductive electrode 24 may be attached to the support structure 18 in a height above the ground so as to be avoid contact with the soil or other elements. In this particular embodiment, the wheels 22 are sized so as to grant a proper distancing with the ground of the conductive electrode 24 which is positioned between them. This features further increases the optimization of the energy consumption since the conductive electrode 24 will not contact the ground.

In the preferred embodiments the use of the conductive electrode 24 in a height above the ground along with the hinged connecting members 15, 17 and central bar 16, ensures that all, or at least most of, the electrical energy will be applied to the plant and not into the soil.

Thus, the present invention provides an advantageous applicator and device for eradicating soil pests. As previously discussed, the application of electrical current directly into the soil may be a general solution for soil pests, but a direct electrical connection through the plant's xylem and phloem to the root borne nematodes ensures a hugely diminished amount of electrical energy wasted through the soil, amongst other advantages. According to the present invention, the electrical connection is stablished through the plant's xylem and phloem and, finally, to the root nematodes.

Therefore, the application of the energy is focused on the stem of the host plant, which further improves the optimization of the energy consumption, since it increases the chances that the conductive electrode will contact only the host plants. Additionally, considering that the contact with the ground enables the flow of electrical energy through the soil, beneficial organisms will not be harmed.

Moreover, root borne nematodes are an increased issue with high humidity and irrigated soils that suffer no dry periods of non-host plants to help naturally control their population. Therefore, the present invention is also efficient to control root borne nematodes in low impedances scenarios promoted by said high humidity, and for economical purposes for the solution to minimize energy per area, covering the maximum amount of unit of area per unit of time while minimizing the amount of energy spent on electrifying the non-target soil parcels. Therefore, the applicators according to the present invention can be used even in these situations.

However, the present invention is not limited to this embodiment and other alternative embodiments are disclosed.

FIG. 4 shows a second embodiment of an applicator 30 according to the present invention. Similarly, to the embodiment of FIGS. 2 and 3, the applicator 30 comprises one support structure 18 that is connected to the careen 12 by means of connecting members 15, 17 and a central bar 16, thus, enabling the applicator 30 to be moved by the moving carrier 10.

In this embodiment, the applicator comprises two electrode plates 34a, 34b, which are attached to the support structure 18 and connectable to the electrical power source. Each of the two electrode plates 34a, 34b comprises a contacting surface for contacting the plant as the applicator is moved by the carrier. In addition, the length of the contacting surface is in the movement direction and is greater than the width of the contacting surface.

As it can be seen, the electrode 34a is a substantially rectangular plate which is made of a conductive material to provide electrical energy to a plant. Each of the electrode plates 34a, 34b comprises a flat region vertically disposed. The flat regions of the electrode plates 34a, 34b face each other forming an aperture for contacting and engaging the plant. Therefore, when the applicator 30 is moved over the crop field to be treated, the stems of the plants are engaged between the electrode plates 34a, 34b enabling an increased contact with the host plant.

Preferably, the electrode plates 34a, 34b can be positioned with a slight inclination with respect to the longitudinal axis of the support structure 18, thus, gradually decreasing the width of the aperture along the length of the electrode plates 34a, 34b. In addition, the width of the aperture is greater on the front portion and decreases such that the contacting surfaces come to close contact on the rear portion. Moreover, the electrode plates 34a, 34b may comprise a curved region in the front portion. The curved regions of each of the electrode plates 34a, 34b extend outward each other. This embodiment increases the capability of engaging the plant's stems between the electrodes 34a, 34b and further increases the contact time and surface.

Furthermore, the electrode plates 34a, 34b are placed so as to be pressed against each other and being configured to be displaced by the stem of the host plant and to return after the contact. Therefore, upon the movement of the applicator along the crop field, the stem of the host plant is engaged within the electrode plates 34a, 34b, which are displaced to an open position while being pressed against the stem. The pressure provided on the plates further increases the contact with the plant and ensures that the energy will be transferred to the plant. After passing by the stem, the electrodes 34a, 35b are returned to the initial position.

In addition to the advantages regarding the energy optimization for controlling root borne nematodes, this embodiment provides a greater surface area when compared to the first embodiment due to the second electrode plate, consequently, increasing the energy that will be applied to the plant.

Preferably, insulating mats 33 may be provided on the sides of the support structure 18, which extend with the same height of the electrode plates 34a, 34b in order to improve the protection and safety to the applicator along the field.

Moreover, the applicator shown in FIG. 4 comprises a rear portion 32 attached to the support structure 18 and supports the applicator 30 so as to ensure the proper positioning and distancing of the electrodes 34a, 34b from the ground. In addition, locomotion means are attached to the rear portion. In this embodiment, the locomotion means are wheels 31 that are attached to the rear portion 32 by means of independent axis. Preferably, the rear portion 32 comprises a gap in the lower portion thereof to provide a passage for the stems of the host plants during operation.

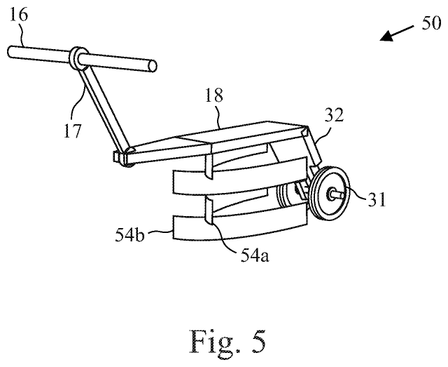

FIG. 5 shows a third embodiment of an applicator 50 according to the present invention. Similarly to the other embodiments that were described, the applicator 30 comprises a support structure 18 that is connected to the careen 12 by means of connecting members 15, 17 and a central bar 16, thus, enabling the applicator 30 to be moved by the moving carrier 10.

In this embodiment, the applicator 50 comprises a plurality of electrode plates, which are provided pairs of electrode bands 54a, 54b. The electrode bands 54a, 54b are electrode plates, but comprising reduced width when to the plates of the second embodiment. In the illustrative embodiment of FIG. 5, the plurality of bands comprises two pairs of electrode bands. However, more pairs of bands may be provided. However, for an applicator with the same size and height, the bands should comprise smaller widths.

The electrode bands 54a, 54b are attached to the support structure 18 so that each pair of electrode bands are disposed above the other. Preferably, the electrodes bands 54a, 54b are attached to the support structure by means of an insulating support (not shown) made of nylon or a fiberglass resin such as TVE. Each of the electrode bands 54a, 54b are fixed to the insulating supports by fixing means such as screws. The electrode bands 54a, 54b are curved with respect to the vertical plane and crosses each other with respect to each other in the horizontal plane. Therefore, the front portions of the pair of bands form an engaging region, wherein the stems of the plants may come into contact as the applicator 50 is moved along the crop field. The electrode bands 54a, 54b are attached to the support structure 18 by means of biasing means which enables the displacement of the electrodes when contact with the plant and then, return to the initial position upon release.

In addition to the advantages regarding the energy optimization for controlling root borne nematodes, this embodiment a greater pressure due to the plurality of electrode bands 54a, 54b engaging the stem of the plants which, thus, ensures the application of electrical energy on the host plant.

Therefore, the present invention provides different embodiments of applicators that increases the contact surface and time of the electrodes with the plants. Moreover, the embodiments according to the present invention enables the use of the applicators for controlling or eradicating root borne organisms, such as nematodes. In addition, the present invention is suitable for the use even with uneven or very irrigated soils.

For operating the devices according to the present invention at least one applicator could be used. In this case, the applicator would be connected to a terminal of the electrical energy source and an element such as an earth disk or a different electrode could be used and connected to the ground. Still, the electrode inserted into the ground should be placed with a sufficient depth within the soil so as to ensure proper flow of the electrical current through the roots of the plants, where the target nematodes are borne. However, this arrangement would not enable all advantages proposed by the invention, the applicator connected to the plant would have increased contact time and surface ensuring proper application of the electrical energy.

Moreover, on top of minimizing the amount of energy spent on the soil volume other than the targeted one directly attached to the roots, using electrodes that are connected to the plants, using their xylem and phloem as conductors to the targeted root borne nematodes in an air-air configuration have increased energy efficiency in low impedances, such as the ones with higher humidity, where the target root borne nematodes thrive and become an agricultural problem. Such an effect is described by the publication of the Zasso's Magazine “Electrode arrangements”, where the following tables can be found.

TABLE 1
Arrangements for two electrodes with constant power source

| Two electrodes - with vs. without earth | | | | Three electrodes - with vs. without earth | | | |
|---|---|---|---|---|---|---|---|
| electrode | | | | electrode | | | |
| Peak | | Converted total | | Peak | | Converted total | |
| power | | power | | power | | power | |
| X < 10 | X > 10 | X < 10 | X > 10 | X < 10 | X > 10 | X < 10 | X > 10 |
| Earth | Earth | Advantage | Without | Earth | Earth | Advantage | Without |
| electrode | electrode | without | earth | electrode | electrode | without | earth |
| up to | slightly | earth | electrode | up to | slightly | earth | electrode |
| factor 2 | better | electrode; | up to | factor 1.5 | better | electrode; | up to |
| better | | only for | factor 2 | better | | only for | factor 1.5 |
| | | X = 0 | better | | | X = 0 | better |
| | | equally | | | | equally | |
| | | good | | | | good | |

TABLE 2
Arrangements for two electrodes with constant power source

| Two vs. Three electrodes without earth electrode | | | | Two vs. three electrodes - with | |
|---|---|---|---|---|---|
| Peak power | | Converted total power | | earth electrode | |
| X < 10 | X > 10 | X < 10 | X > 10 | X < 10 | X > 10 |
| Three | Three | Advantage | Three | Advantage | Three |
| electrodes | electrodes | three | electrodes | three | electrodes up |
| at least | up to factor | electrodes; | up to factor | electrodes; | to factor 2 |
| factor 1.33 | 2 better | only for X = 0 | 1.5 better | only for x = 0 | better |
| better | | equally good | | equally good | |

Therefore, the devices according to the present invention preferably comprise at least one pair of applicators to enable the flow of the electrical current. Such arrangements for operating air-air electrodes and the techniques for controlling the flow of electrical current are already known in prior art.

In the preferred embodiments, the electrical energy source 14 is an electronic converter that is supplied by an alternator. In this case the first applicator is connected to the positive pole of the converter and the second applicator is connected to the negative pole of the converter.

FIG. 6 shows a pair of electrical current applicators according to embodiments of the present invention. As it can be seen, the two applicators 30, 40 are disposed in a horizontal arrangement wherein the electrical energy may flow sideways during operation. In this illustrative embodiment, the applicators 30, 40 are connected by means of the central bar 16. As it can be understood by a person skilled in the art, the central bar 16 may comprise several pairs of applicators adjacently forming a row of applicators so as to cover the width of the field that it is intended to be treated. For each pair of applicators according to this embodiment, the first applicator 30 may be connected to the positive pole of the electrical converter, while the second applicator 40 is connected to the negative pole. When both applicators 30, 40 contact stems of host plants, the electrical current is then applied.

It is important to note that, although FIG. 6 shows the pair of the applicators 30 comprising two electrode plates 34a, 34b, as seen in FIG. 4, this configuration can also be used with the applicator 20 comprising a curved electrode plate 24 or applicator 50 comprising a plurality of electrode bands 54a, 54b.

Moreover, FIG. 6 shows some variations in the embodiments of each one of the applicators. Firstly, it is important to note that in the embodiment of the applicator 30 an additional support portion 37 is provided wherein additional wheels are disposed. The additional support and locomotion means may be advantageous to improve the movement of the applicator along the field and aid in adjusting the height of the applicators and, consequently, avoiding the contact of the electrodes with the soil.

Alternatively, the electrodes may be disposed in a longitudinal manner, thus, the functioning of a single pair or allowing two rows of electrodes in the device. As seen in FIG. 7, the applicator 60 comprises two support structures 18, 19. The applicator 60 comprises two pairs of conductive electrode plates 34a, 34b such as in the embodiment of FIG. 4. However, the plurality of electrode bands 54a, 54b could be used.

In the rear portion of the support structure 18, the second support structure 19 is provided, wherein the second pair of electrode plates 35a, 35b are attached. The second pair of electrode plates 35a, 35b are arranged in a similar manner as the first pair of electrode plates 34a, 34b, but each pair of electrode plates is connected to an opposite pole of the electronic converter. This configuration allows the electrical energy to flow from the first pair of electrode plates 34a, 34b to the second pair of electrode plates 35a, 35b.

Still, the central bar 16 may comprise several applicators 60 along its width, so as to form a row of applicator comprising two pairs of electrode plates. In this case, the energy will be capable of flowing both to the back, i.e., flowing to the from the first pair of electrode plate to the second electrode plate of the same applicator, or sideways to an adjacent applicator comprising two pair of electrode plates.

Therefore, the present invention solves the technical problem of providing an apparatus that ensure the connection, optimizes the electrical path, ensures the usage of maximum power and enough energy, while not wasting electrical energy to heat up the soil and minimizing effects on other potentially beneficial organisms.

While various example embodiments have been described above, it should be understood that they have been presented by way of example, and not limitation. It will be apparent to persons skilled in the relevant art(s) that various changes in form and detail can be made therein.

What is claimed is:

1. Applicator (20, 30, 40) for applying electrical current into a plant, the applicator arranged to be carried by a moving carrier, characterized by comprising:
at least one insulating support structure (18) comprising a connecting member (17) for attaching the applicator to the moving carrier (10) and locomotion means (22, 31, 36) for moving the applicator along with the carrier; and
at least one conductive electrode (24, 34, 35, 54) attached to the insulating support structure (18) and electrically connectable to a terminal of an electrical power source, the at least two conductive electrodes (24, 34, 35, 54) comprising a contacting surface for contacting the plant as the applicator is moved by the carrier, wherein a length of the contacting surface extends in the movement direction and is greater than a width of the contacting surface.

2. Applicator according to claim 1, characterized in that the conductive electrode (24) is a curved plate electrode that is attached to the support structure (18) and the contacting surface faces toward the movement direction of the applicator.

3. Applicator according to claim 2, characterized in that the locomotion means are insulating wheels (22) for guiding the applicator and holding the support structure (18) above the ground, wherein the insulating wheels (22) are attached to the support structure (18) by means of a wheel support (23).

4. Applicator according to claim 1, characterized by comprising two conductive electrodes (34a, 34b) that are attached to the support structure (18) and each of the two conductive electrodes (34a, 34b) comprises a flat region vertically disposed, wherein the flat regions face each other forming an aperture between them for contacting the plant.

5. Applicator according to claim 4, characterized in that the two conductive electrodes (34a, 34b) are inclined with respect to each other, and the width of the aperture gradually decreases along the length of the electrodes (34a, 34b).

6. Applicator according to claim 4 or 5, characterized in that each of the two conductive electrodes (34a, 34b) comprises a curved region that extends outward from the flat region.

7. Applicator according to claims 4 to 6, characterized in that the conductive electrodes (34a, 34b) are pressed against each other by means of biasing means, wherein the conductive electrodes (34a, 34b) move away from each other when contacting with the plant and return to the initial position when the plant is released.

8. Applicator according to claim 1, characterized by comprising at least one pair of conductive electrode bands (54a, 54b) that are attached to the support structure (18), wherein each of the electrode bands (54a, 54b) is positioned one above the other, the electrode bands (54a, 54b) are curved with respect to the vertical plane and crosses each other with respect to each other in the horizontal plane.

9. Applicator according to claim 8, characterized by comprising two pairs of electrode bands (54a, 54b), wherein one pair of electrode bands is positioned above the other.

10. Applicator according to any one of the preceding claims,
characterized by comprising insulating mats (33) for protecting the at least one conductive electrode.

11. Applicator according to any one of the preceding claims,
characterized in that the locomotion means are wheels (31) or skis.

12. Applicator according to any one of the preceding claims,
characterized in that the support structure (18) comprises a rear portion (32) comprising a gap for allowing the passage of the plant, wherein the locomotion means are attached to rear portion (32) of the support structure.

13. Applicator according to any one of the preceding claims,
characterized in that the support structure comprises a front support portion (37) comprising a gap for allowing the passage of the plant, and comprising additional locomotion means.

14. Applicator according to any one of the preceding claims,
characterized by comprising a second support structure (19) comprising at least one conductive electrode connected to a different terminal of the electrical source.

15. Device for applying electrical current into a plant, characterized by comprising:
a moving carrier (10);
an electrical power source;
at least one applicator (20, 30, 40, 50, 60) connected to the moving carrier (10) and the electrical power source, wherein the applicator comprises at least one support structure (18) comprising a connecting member (17) for attaching the applicator to the moving carrier and locomotion means (22, 31, 36) for moving the applicator along with the carrier; and
at least one conductive electrode (24, 34, 35, 54) attached to the support structure (18) and connectable to a terminal of an electrical power source, the at least one conductive electrode (24, 34, 35, 54) comprising a contacting surface for contacting the plant as the applicator is moved by the carrier, wherein a length of the contacting surface is in the movement direction and extends greater than a width of the contacting surface.

16. Device according to claim 15 characterized by comprising a central bar (16) and connecting members (15, 17) for attaching the at least one applicator (20, 30, 40, 50, 60), wherein the central bar and connecting members are made of an insulating material.

17. Device according to claim 16, characterized in that the connecting members (15, 17) are attached to the moving carrier (10), the central bar (16) and the at least one applicator (20, 30, 40, 50) in a hinged manner.

18. Device according to claim any one of claims 15 to 17, characterized in that the electrical power source is an alternator connected to an electronic converter.

19. Device according to any one of claims 15 to 18, characterized in that the conductive electrode (24) is a curved electrode plate that is attached to the support structure (18) and the contacting surface faces toward the movement direction of the applicator.

20. Device according any one of claims 15 to 18, characterized by comprising two conductive electrodes (34a, 34b) that are attached to the support structure (18) and each of the two conductive electrodes (34a, 34b) comprises a flat region disposed in the vertical plane and parallel to the movement direction, wherein the flat regions are parallel and faces each other forming an aperture for contacting the plant.

21. Device according to claim 20, characterized in that each of the two conductive electrodes (34a, 34b) comprises a curved region that extends outward from the flat region to engage the plant in the aperture.

22. Device according to claim 19 or 20, characterized in that the conductive electrodes (34a, 34b) are pressed against other by means of biasing means, wherein the conductive electrodes (34a, 34b) move away from each other when contacting with the plant and return to the initial position when the plant is released.

23. Device according to any one of claims 15 to 18, characterized by comprising at least one pair of conductive electrode bands (35a, 35b) that are attached to the support structure (18), wherein each of the electrode bands (35a, 35b) positioned one above the other and the electrode bands (35a, 35b) are curved with respect to the vertical plane crosses each other with respect to each other in the horizontal plane.

24. Device according to claim 23, characterized by comprising two pairs of electrode bands (35a, 35b), wherein one pair of electrode bands is positioned above the other.
